(19) United States
(12) Patent Application Publication
(10) Pub. No.: US 2004/0115602 A1
(43) Pub. Date: Jun. 17, 2004

(54) IntelligentNet (iNet)

(76) Inventor: Zouhua Ding, Tampa, FL (US)

Correspondence Address: Zouhua Ding, #H3, 14420 Hellenic Dr., Tampa, FL, 33613, US

(21) Appl. No.: 10/317,228

(22) Filed: Dec. 13, 2002

(51) Int. Cl. G09B 5/00

(52) U.S. Cl. 434/201; 434/188

(57) ABSTRACT

This invention is a toy for kids from grade 1 to high school to study Mathematics. The set up of this toy is like a net. Kids can be benefited from the following. First of all, kids can do mixture operation of addition (+), subtraction (−), multiplication (*) and division (/). Specifically, this toy can help kids to solve problems such as: 1+2+3+ . . . +98+99+100. Second, if the net is well organized, kids can present some basic logical problems. Third, kids will gain analysis and design ability. Finally, kids can get basic knowledge of computer.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISK APPENDIX

Not Applicable.

### BACKGROUND OF THE INVENTION

The knowledge behind this invention is: Mathematics and Computer.

The motivation comes from the requests of those parents who need better Math toys to help their kids to study Math. The prevailing Math toys in the market attract kid attention with their realistic animation, colorful pictures and beautiful voice. However, the hiding mathematics is too directly, the presentation is static and simply limited to problems -> answers. It is better to have a toy which can train kids' capability rather than just solve some problems.

### BRIEF SUMMARY OF THE INVENTION

This invention is a toy for kids from grade 1 to high school to learn mathematics. The set up of this toy is like a net. There are four items: I/O panel, place, Operator and link. Link is used to connect a place to an operator or connect a place to I/O Panel. I/O panel is responsible to initiate a place with alphabets or numbers. Place is going to display received data. Operator will do operation on the received data and form a new expression. The final output will be displayed in I/O panel, which includes a calculated Answer and an Expression indicating how this Answer has been generated.

There are some advantages over the current math toys. First of all, kids can do mixture operation of addition (+), subtraction (-), multiplication (*) and division (/) . Specifically, this toy can help kids to solve problems such as: 1+2+3+ . . . +98+99+100. Secondly, if the net is well organized, kids can present some basic logical problems. Third, kids will gain analysis and design ability. Finally, kids can get basic knowledge of computer.

### BRIEF DESCRIPTION OF THE SEVERAL VIEWS OF THE DRAWING

FIG. 1: The outlook of I/O Panel.

FIG. 2: The display when I/O Panel is open.

FIG. 3: The outlook of Place.

FIG. 4: The outlook of Calculation Operator.

FIG. 5: The outlook of Comparing Operator.

FIG. 6: The outlook of AT operator.

FIG. 7: The outlook of Link.

FIG. 8: The net set up for Example 1.

FIG. 9: A Place in Example 1 has been assigned a value.

FIG. 10: Another Place in Example 1 has been assigned a value.

FIG. 11: The running net of Example 1.

FIG. 12: The net set up of Example 2.

FIG. 13: The initialized net of Example 2.

FIG. 14: The running net of Example 2.

FIG. 15: The net set up of Example 3.

FIG. 16: The initialized net of Example 3.

FIG. 17: The running net of Example 3.

FIG. 18: The net set up of Example 4.

FIG. 19: The initialized net of Example 4.

FIG. 20: The running net with input “A” of Example 4.

FIG. 21: The running net with input “B” of Example 4.

FIG. 22: The running net with input “C” of Example 4.

FIG. 23: The display of I/O Panel when “On” button is pressed.

FIG. 24: Main Manu screen of I/O Panel.

FIG. 25: Problem screen of I/O Panel.

FIG. 26: Input Screen of I/O Panel.

FIG. 27: Output Screen of I/O Panel.

FIG. 28: Score Screen of I/O Panel.

FIG. 29: Basic objects and their values for “Place”.

FIG. 30: Basic objects and their values for Calculation Operator.

FIG. 31: Basic objects and their values for Comparing Operator.

FIG. 32: Basic objects and their values for AT Operator.

### DETAILED DESCRIPTION OF THE INVENTION

There are four elements for this toy: I/O panel, place, Operator and link. Operator has three types: Calculation operator, Comparing Operator and AT Operator. The following are the specifications for each element. Each specification is labeled by “S”.

8.1 I/O Panel

S: Panel must have a battery to provide the electricity to all the Places and Operators through Links.

S: Panel can be turned on and turned off.

S: Panel must have a port to send input out (out-port) to the net and a port to receive data (in-port) from the net. This in-port also sends control messages to a place. Panel must have a port to receive data from admin.

S: Panel must have five screens to display 1) Main Manu, 2) Problem screen to show all problems pre-stored from admin port, 3) Input screen to display the typed characters waiting to be sent to the net, 4) Output screen to display the data from the net, and 5) Score screen to show the solved problems and the problems being touched but not solved yet and the scores. Panel must have a mechanism to back and forth these five screens.

S: Panel must have a mechanism to up and down the Problem screen and to choose a problem.

S: On Input screen, the characters in the input can be deleted and characters can be inserted to the input. The panel must have a mechanism to send input out to a place when it is ready.

S: All the inputs sent out are composed of the following characters. Alphabets: A, B, C, D, E, F, G, H, I, J, K, L, M, N, O, P, Q, R, S, T, U, V, W, X, Y, Z; Digits: 0, 1, 2, 3, 4, 5, 6, 7, 8, 9; and Symbols “.”, “-”. The rest symbols: “[“and”]” are for the future use.

S: The Output screen will show the pre-chosen problem (if chosen) and the data from net. This data includes two parts: 1) an Answer, and 2) an expression reflecting the created net. All answers are composed of either 26 alphabets or 10 digits and symbols:-, /. All expressions are composed of 26 alphabets; 10 digits; calculation symbols: +,−,×,/; assignment symbol: =; comparing symbols: ==, !=, >, >=, <, <=; and symbols: .,-;

S: The Score screen will show the solved problems and the problems being touched but not solved yet.

S: Panel must have a mechanism to send control message “Start” to the created net to start the net after the net is initialized. Initialization means that the places have been assigned values, i.e. either numbers or alphabets or strings.

S: Panel must have a mechanism to send control message “Reset” to the created net to reset the net. Reset means to clean all the values in the places and operators.

S: Panel should tell the connected places that the connected part is I/O panel.

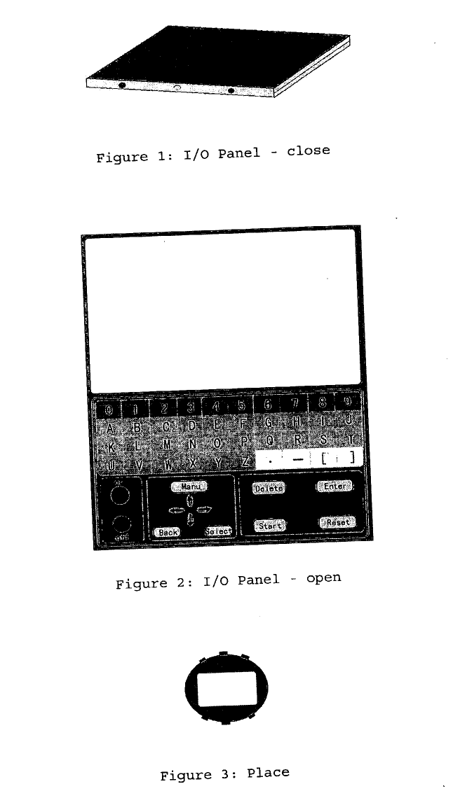

S: The outlook of I/O panel should look like the FIG. 1. It is about 8 cm long, 6 cm wide and 1 cm high. When it is open, it should look like FIG. 2. The upper half is the display screen and the lower half is the keyboard.

8.2 Place

S: Each place must have three In Ports (in-port) to receive data and three Out Ports (out-port) to pass out data. We use I1, I2 and I3 to denote in ports, and use O1, O2, and O3 to denote out ports. A port is activated only if this port has a link connected to it. Each place has a screen to display the received data. The outlook of Place is like FIG. 3.

S. A place can pass the electricity from out-ports to in-ports.

S: A place should know it is connected to I/O panel or to an operator.

S: A place will receive “start” command sent by I/O panel from activated out-ports and passes it out to operators through activated in-ports. If the place has no activated in-ports or the activated in-port is connected to I/O panel, then this place starts to move the contained value to the connected operator to be processed. This place should change “Reset” status to “none”.

S: A place will receive “Reset” command sent by I/O panel from activated out-ports and passes it out to operators through activated in-ports. If this place has no activated in-ports or the activated in-port is connected to I/O panel, then stops. This place should change “Start” status to “none”.

S: A place must have a memory to keep the port status: activated and non-activated; Default: non-activated

S: A place must have a memory to track the “Start” status for each port: passed, received and none; Default: none.

S: A place must have a memory to track the “Reset” status for each port: passed, received and none; Default: none.

S: Each place should have a memory to store the data received from in-ports. Data includes Answer and Expression. Answer can be displayed on the screen. Both parts will be passed out through the activated out-ports. Each time, only one in-port is working, the data received can be overwritten by the new coming data from other in-ports. If a place is initialized by I/O panel, then the Answer and the Expression will take the same value as the initialized value. See FIG. 29.

S: when an in-port receives data, the place will flash once with green light (keep it until the net is shut down), waits for 2 seconds and then the data will be passed out through all activated out-ports.

S: A place will pass the data to operators after it receives a “trigger” signal from an in-port.

8.3 Operators

S: An operator should pass the electricity from out-ports to in-ports.

S: An operator should tell the connected places that the connected part is an operator.

S: An operator will receive “start” command from activated out-ports and passes it out to places through activated in-ports. This operator should change “Reset” status to “none”.

S: An operator will receive “Reset” command from activated out-ports and passes it out to places through activated in-ports. This operator should change “Start” status to “none”.

S: An operator must have a memory to keep the port status: activated and non-activated; Default: non-activated

S: An operator must have a memory to track the “Start” status: passed, received and none; Default: none.

S: An operator must have a memory to track the “Reset” status: passed, received and none; Default: none.

S: An operator must have a mechanism to adjust different operations.

S: The screen(s) of the operator will flash once with green light after it receives data from the in-port(s) and keep it until the net is reset or I/O Panel is turned off.

S: All operators will wait 2 seconds and then sends the operated data to out ports.

8.3.1 Calculation Operator

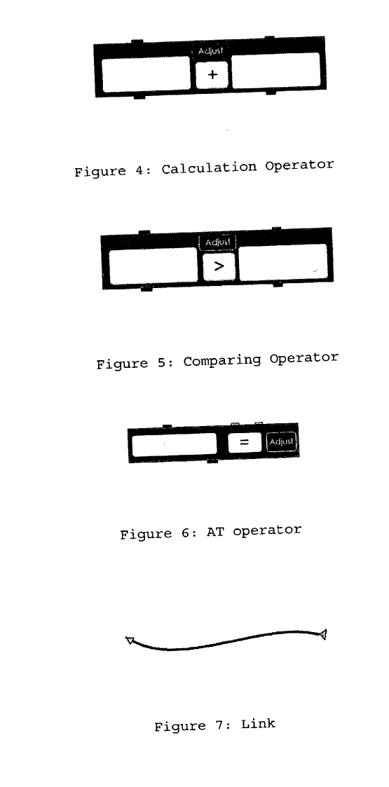

S: A calculation operator should have 2 ports in (in-port) and one port out (out-port) . The in-ports are used to receive data while out-port is used to send out data. Each in-port has a screen to associate with. These screens are used to display the Answers from the received data. A calculation operator has four operations: addition (+), subtraction (−), multiplication (*) and division (/). The default is (+). See FIG. 4.

S: An operator must have a memory to store the received data from in-ports. This data includes: Answer and Expression.

S: Only numbers can do operation. This is the pre-defined condition. If not satisfied, the screens will keep flashing.

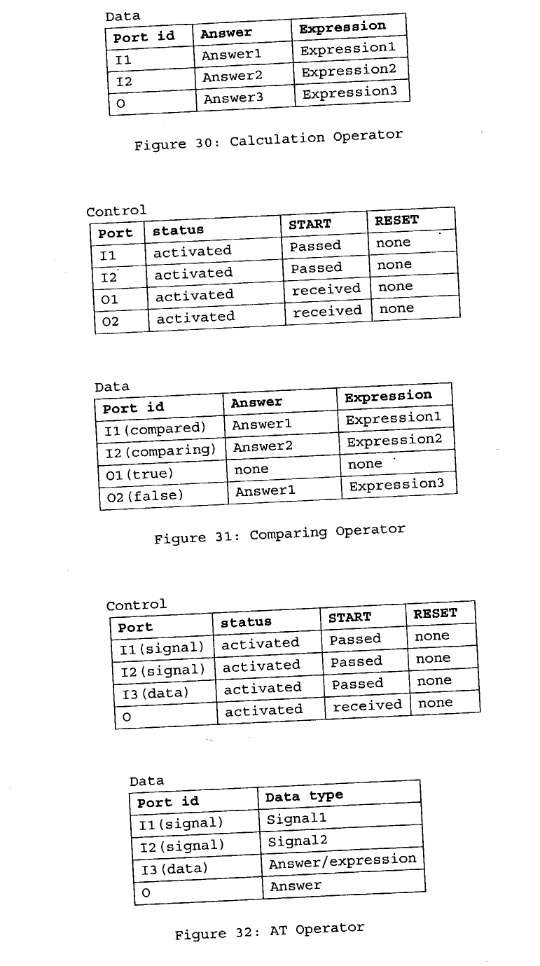

S: An operator must perform calculation on two received Answers with current operation and gives a new Answer. Meanwhile it will form new Expression based on the received expression and the current operation. See FIG. 30.

8.3.2 Comparing Operator

S: A compare operator should have 2 ports in (in-port) and 2 ports out (out-port). The in-ports are used to receive data while out-ports are used to send out data. Among in-ports, one receives “Compared Dada” and the other receives “Comparing Data”. Each in-port has a screen to associate with to display the Answer from the data. Among out-ports, one is called “true” and the other is called “false”. Both out-ports will send “Compared Data” out, but only one is working at a time. Comparing Operator has the following operations: bigger (>), bigger or equal (>=), less (<), less or equal (<=), equal (==), and not equal (!=). The default is (>). See FIG. 5.

S: The comparing is between numbers or alphabets. For example, assume the comparing operation is “>” and the two coming Answers are: A, and B. Here “A” is the compared Answer while “B” is the comparing Answer. Since “A<B”, the new statement “A<B” will be created and added to the compared Expression which will be sent to false port together with Answer “A”. See FIG. 31.

8.3.3 AT operator

S: An AT operator must have three ports in (in-port) and one port out (out-port). Among in-ports, two ports receive signals (signal-port) and one port receives data (data-port) . There is a screen associated with the data-port to display the Answer in the received data. An AT Operator has three operations: Assign (=), Trigger (->) and Assign and Trigger (=->). The default is (=). See FIG. 6.

S: If “Assign” operation is chosen, the Answer from data-port will be sent to the out port. If “Trigger operation” is chosen, then this operator must wait until all signals coming from the activated signal-ports and send out a signal to out port with no Answers and Expressions passed. If “Assign and Trigger” operation is chosen, then this operator needs to wait all signals from all activated signal-ports and data from data-port, then sends the Answer from data-port to out port. Otherwise, the screen will keep flashing. See FIG. 32.

8.4 Link

S: A link will pass data, control message and electricity.

S: A link should have two ends: one is called Male and the other is called Female. The Male end will hook to the in ports of an operator or a place or the output port of I/O panel while the Female end will hook to the out ports of an operator or a place or the input port of I/O panel. Moreover, one link can hook to another link. See FIG. 7.

S: A link can be twisted and bended. A link should be safe.

### EXAMPLES

### 8.5.1 Example 1

1+2=?

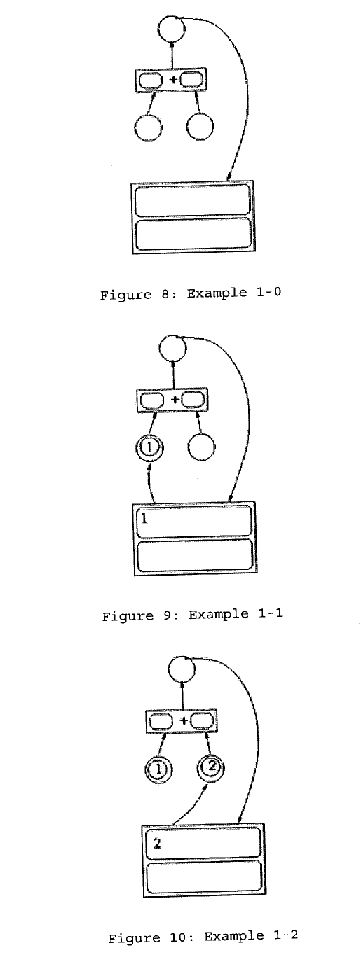

1^{st} step: Create the net. We need three Places: two places for numbers 1 and 2, the third place for the sum. One Operation operator is needed. The default operation in the operator is “+”. We use three Links to connect the operator to all places and one Link to connect the third place to the out port of I/O panel. The display is as in the FIG. 8: Example1-0.

2^{nd} step: Initialize the net. Connect the in port of I/O panel to the first place with a Link. Change the Manu to Input screen. Type number “1” and it will be shown on the input screen, then hit “Enter” button, number “1” will go to this place, which will flash once with green light and keep it to the end of the game. The display is as in FIG. 9: Example1-1.

Similarly, we can input number “2” to the second place. Switch the link that connects to the first place to the second place. Delete the number 1 on the screen by hitting delete button. Type number “2” and it will be shown on the screen. Hit “Enter” button, then number “2” will go to the second place, which will flash once like the first place and keep the light to the end of the game. The display is as in FIG. 10: Example1-2.

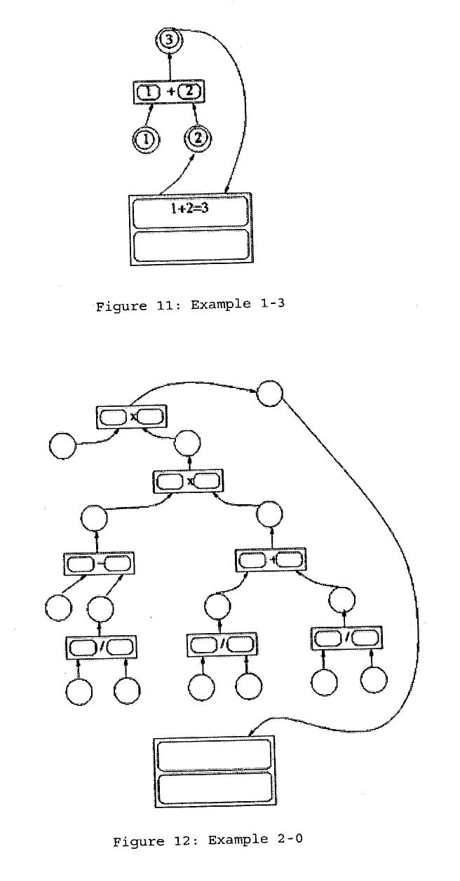

3^{rd} step: Run the net. Now we have the initialized net. Hit the “start” button, the net starts to run. The screen of I/O panel will be changed to Output screen. The number “1” and “2” will be moved to the Calculation Operator. The screen of calculation operator will flash one time, and two seconds later, the sum will be moved to the 3^{rd} place. The screen on of this place will flash one time and one second later, the sum will be sent to I/O panel. The result will be displayed on the output screen. It is “1+2=3”. We will get not just the Answer “3” but also the Arithmetic Expression. If the net is not in correct set up, we will get other expressions. The display is as in FIG. 11: Example1-3.

### 8.5.2 Example2

2(1−⅓) (⅘+½)=?

1^{st} step: Create the net. Here the numbers ⅓, ⅘ and ½ can be decomposed as 1 divided by 3, 4 divided by 5 and 1 divided by 2. The left side has three equivalent expressions: a). 2[(1−⅓) (⅘+½)], b). [2(1−⅓)] (⅘+½) , and c). (1−⅓) [2(⅘+½)]. However, different expression will lead to different net. We choose the a) as the example. First we calculate “1−⅓ and “⅘+½” in parallel, then multiply these two fractions, and finally multiply the product by “2”. The display is as in FIG. 12: Example2-0.

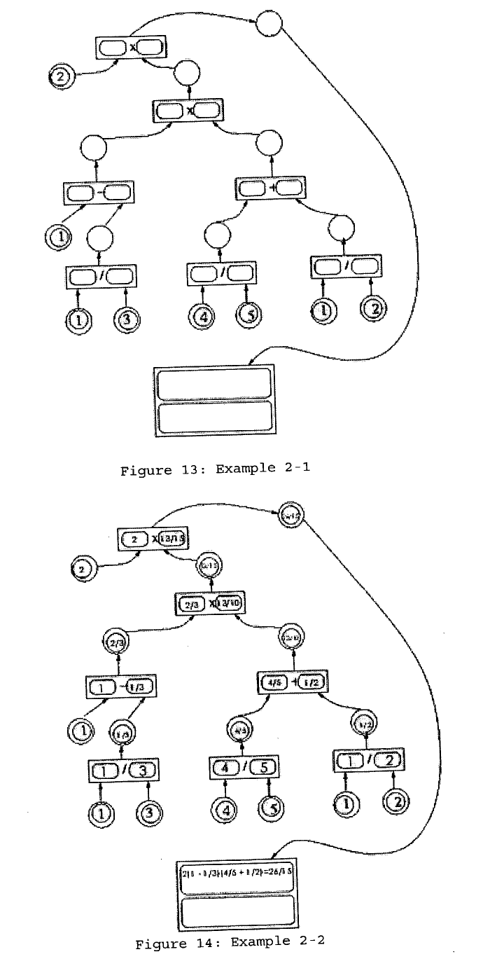

2^{nd} step: Initialize the net. There are many places in the net. Keep in mind which places are needed to be initialized when you design the net. Since we choose a) as the illustration, numbers: 1, 3, 4, 5, 1, 2, and 2 will be assigned to the places as in FIG. 13: Example2-1.

3^{rd} step: Run the net. Hit the button: “Start”, then the net starts to run. Those places will flash once when fractions: “⅓”, ⅘” and “½” come, and then the places with “⅔” and “13/10”, then the place with “13/15 ”, finally, the place with “26/15”. The output (including calculated Answer and Expression) will be displayed on the Output screen of I/O Panel. The display is as in FIG. 14: Example2-2. The output will tell whether the created net matches the expression or not.

### 8.5.3 Example 3

1+2+3+ . . . +100=?

This example will test AT Operator and Comparing Operator. Let S =1+2+3+ . . . +100. This expression can be decomposed as:

S0=0;

S1=S+1;

S2=S1+2;

S3=s2+3;

S4=s3+4;

. . .

S100=S99+100;

S=S100.

If we use one letter S to represent all those variables: S0, S1, S2, . . . , S100, the above expressions can be rewritten as:

S=0;

S=S+1;

S=S+2;

S=S+3;

S=S+4;

S=S+100;

Let “i” be another variable that can take values: 1,2,3, . . . , 100, then, the above equations can be rewritten as:

S=0+i; i=0;

S=S+i; i=1;

S=S+i; i=2;

S=S+i; i=3;

S=S+i; i=4;

. . .

S=S+i; i=100;

We will see that the expression “S=S+i” will repeat 100 times as i increases from 0 to 100. Thus, three results can be implied from this statement: 1) There are two places for variable “S” and “i”, 2) there are two loops to change the values of variables “S” and “i”, 3) there is a condition checking for variable “i”, all the values of “i” must be less or equal to “100”. Loops will be broken as “i” meets number “101”.

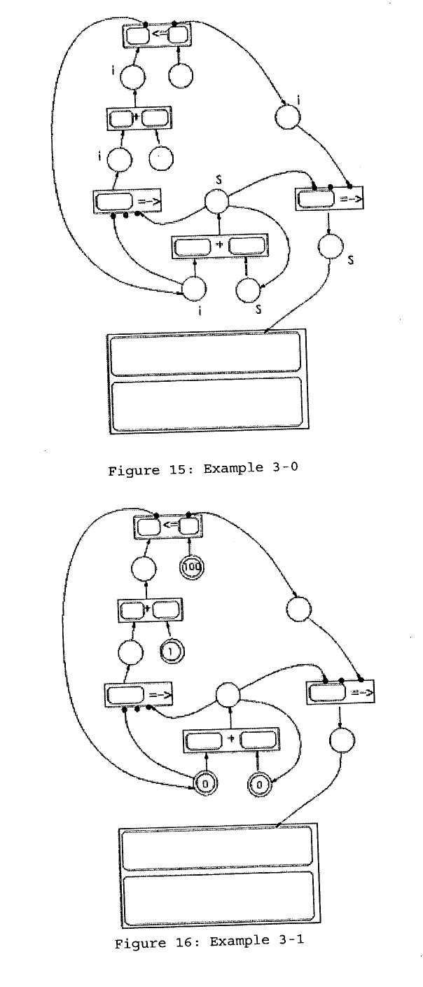

1^{st} step: Create the net. It is shown as in FIG. 15: Example3-0. On the bottom, there are two places: the left one is for variable “i” and the right one is for variable “S”. The third place is still for “S”, which is the sum: “S=S+i”. We see that “S” has three outputs: the first one is being sent back as new input to “S”, the second is used to trigger variable “i” to increase by 1, the third is to be displayed on the screen together with the condition when i=101.

2^{nd} step: Initialize the net. Assign “0” to “i” and “S” in the first two places. Input “1” and “100” to the places that will do addition and comparing with variable “i” . The display is as in FIG. 16: Example3-1.

3^{rd} step: Run the net. When hit the “start” button, we will see that the screens for “S” and “I” will flash 100 times, i.e. the loops for “i” and “S” will repeat 100 times. And finally when “i” meets 101, the sum will be outputted to I/O panel together with a expression:

1+2+3+ . . . +98+99+100=5050.

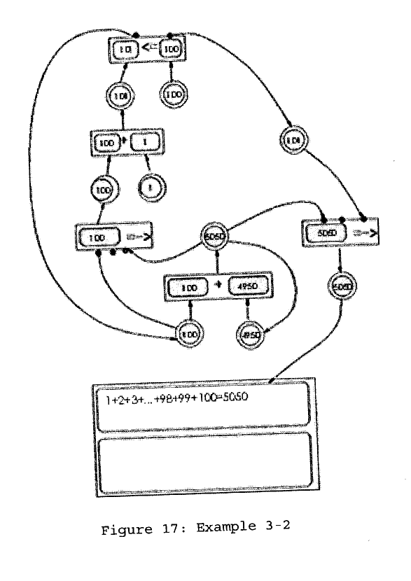

The display is as in FIG. 17: Example3-2.

### 8.5.4 Example 4

If input==“A”

Output=“apple”;

Else If input ==“B”

Output=“bee”;

Else

Output=“opps”

This example is going to test “if” and “else” statement. Depending on the character you typed, the output screen of I/O panel will display corresponding messages. If you type “A”, then “apple” will be displayed on the screen; if “B” is typed, then “bee” will be displayed on the screen; otherwise, “oops” will be displayed.

Remark: We can design a net to display messages with more than one input.

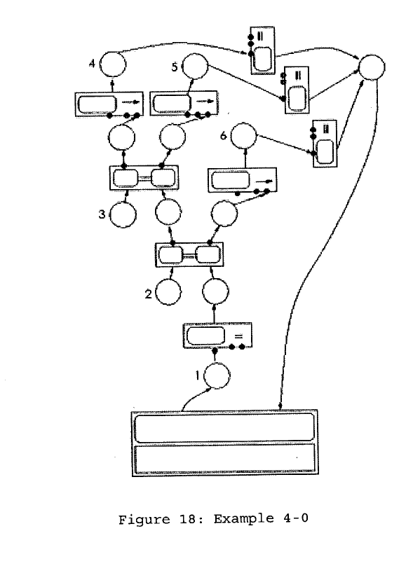

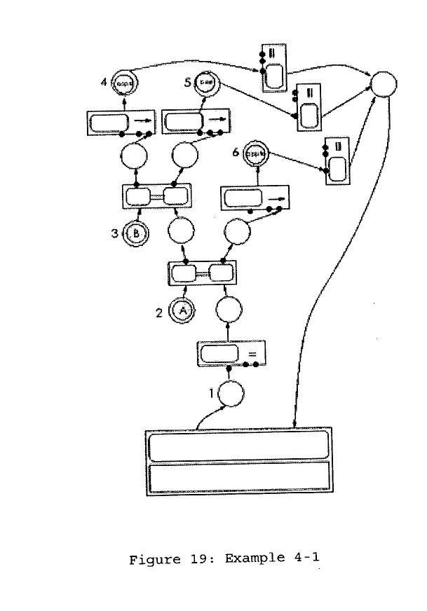

1^{st} step: Create the net. We will learn how to use Assign Operator “=”, Comparing Operator “==” and Trigger Operator “→”. Places (2) and (3) will be assigned values “A” and “B”, respectively. Places (4), (5) and (6) will be assigned message “oops”, “bee” and “apple”, respectively. The place (1) will receive input from I/O penal. Then it will pass the value to the new place to compare with (2). If two values are equal, this value (“A”) will trigger the message in (6) to be sent to I/O panel, otherwise the input will be moved to another place to compare with (3), and so on. The display is as in FIG. 18: example4-0

2^{nd} step: Initialize the net. Assign the values “A”, “B”, “apple”, “bee” and “oops” to the places (2)(3)(6)(5)(4) as in the FIG. 19: Example4-1.

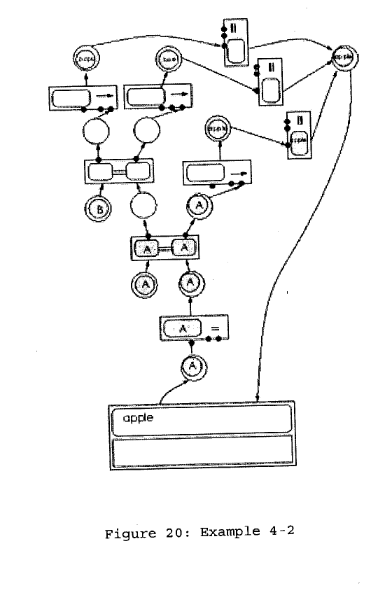

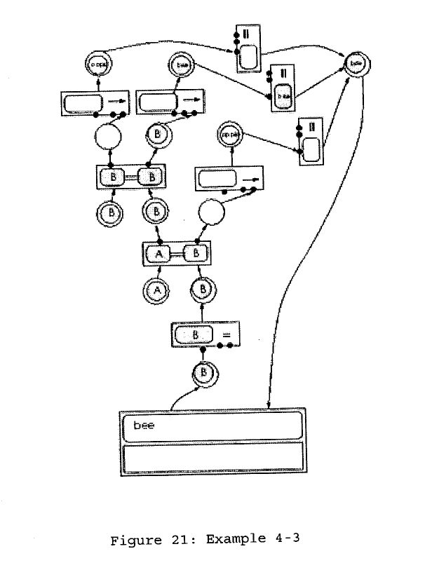

3^{rd} step: Run the net. Now input character “A” from Input Screen of I/O Panel, Place (1) will send “A” to compare with “A” in place (2). They are equal, so the input will be sent a signal to trigger the message “apple” to be sent to I/O panel. We will get “apple” on the Output screen as in FIG. 20: Example4-2. Delete “A”, enter “B”. Then place (1) will pass “B” to a place to compare with “A” in place (2). Obviously, they are not equal. The character “B” will be continually moved to a place to compare with “B”in place (3) . Like example4-2, we will get “bee” on the Output screen as in FIG. 21: Example4-3.

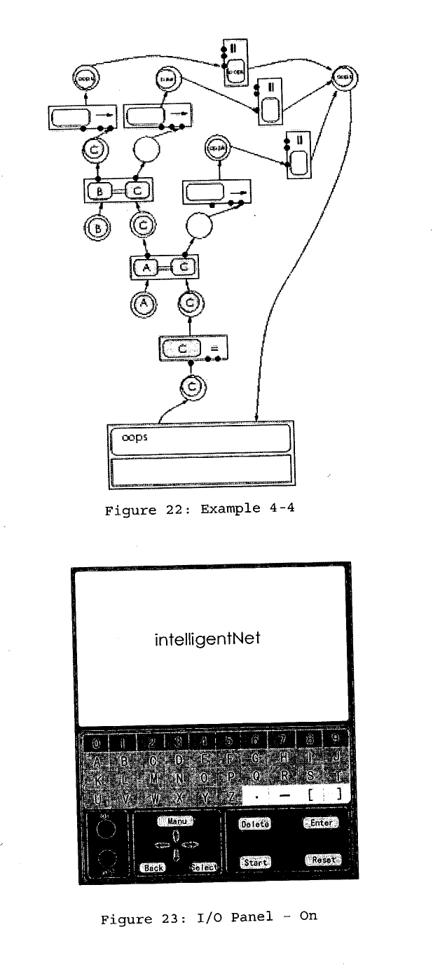

Delete “B” and enter any other characters, say “C”, then we will get “oops” on the output screen as in FIG. 22: Example4-4.

8.6 User Manu

The out look of I/O panel looks like FIG. 1. The I/O has three ports: one port for data out, one port for data and the last one for administration. It contains battery inside.

When open I/O panel, it is as in FIG. 2. The upper half is the screen to display data. The lower half has 10 digits: 0, 1, 2, 3, 4, 5, 6, 7, 8, 9; 26 alphabets; 4 symbols: . ,-, [, ]; “On” and “Off” buttons; “Manu”, “Back” and “Select” buttons; and “Delete”, “Start”, “Enter” and “Reset” buttons.

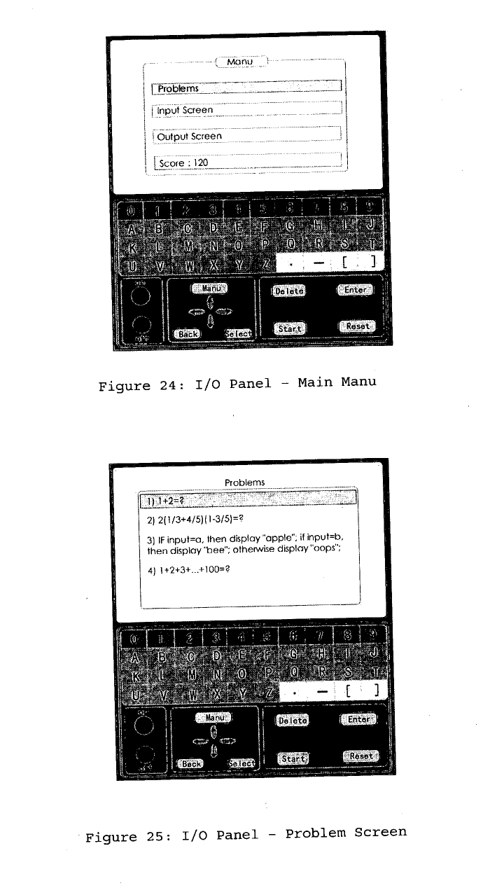

Now hit “On” button, the panel will be turned on as in FIG. 23. Hit “Main” button, we get four choices on the screen: Problems, Input Screen, Output Screen and Score. See FIG. 24.

If choosing Problems, we will get Problems screen as FIG. 25.

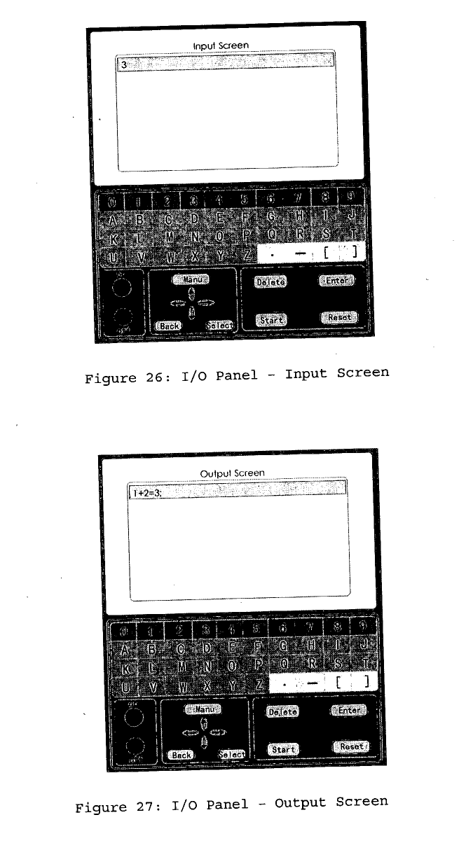

By using “up” and “down” arrows together with “Select” button, we can pick any problems. Now back to Main Manu, and use down arrow and Select button to choose Input Screen. Type 3, the number 3 will show on the screen, and then press “Enter” button, this number will be sent out. See FIG. 26.

There are two ways to get to Output screen. One is to press “Start” button which will also start the created net; another is Back to Main Manu screen. Move down arrow on the Manu screen and select Output screen. This screen will display the data from the net. For example, the Expression and the Answer: 1+2=3. See FIG. 27.

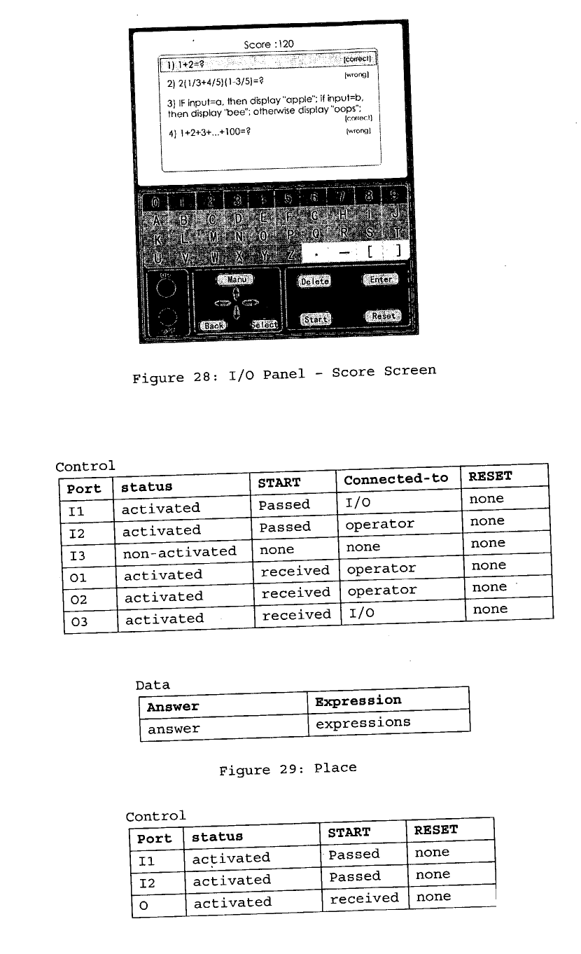

The last item on Main Manu is to display the score. This screen will show which problems have been solved correctly and which problems have been touched but not being solved correctly. See FIG. 28.

1. Any person or company wants to make the toys with the similar design or similar functions as that of intelligetNet (iNet) needs to get permission from the inventor of this invention.

2. Any person or company wants to sell the toys with the similar design or similar functions as that of intelligetNet (iNet) needs to get permission from the inventor of this invention.
